(19) United States
(12) Patent Application Publication
(10) Pub. No.: US 2025/0253387 A1
(43) Pub. Date: Aug. 7, 2025

(54) HIGH VOLTAGE AND FLASH POINT ELECTROLYTE FOR LITHIUM METAL BATTERY

(71) Applicant: Nano and Advanced Materials Institute Limited, Hong Kong (HK)

(72) Inventors: Wai Chung LI, Hong Kong (HK); Wei HUANG, Hong Kong (HK); Soon Yee LIEW, Hong Kong (HK); Qiu Hong WANG, Hong Kong (HK); Chi Ho KWOK, Hong Kong (HK); Shengbo LU, Hong Kong (HK); Li FU, Hong Kong (HK)

(21) Appl. No.: 19/014,244

(22) Filed: Jan. 9, 2025

Related U.S. Application Data
(60) Provisional application No. 63/548,807, filed on Feb. 1, 2024.

(51) Int. Cl. H01M 10/052; H01M 4/02; H01M 4/131; H01M 4/134; H01M 4/40; H01M 4/66; H01M 10/0567; H01M 10/0568; H01M 50/414

(52) U.S. Cl. CPC H01M 10/052; H01M 4/131; H01M 4/134; H01M 4/405; H01M 4/661; H01M 10/0567; H01M 10/0568; H01M 50/414; H01M 2004/027; H01M 2004/028

(57) ABSTRACT

The present invention relates to a high-voltage lithium metal battery, characterized by its non-flammability due to the high flash point and high thermal stability of its specifically designed electrolyte, thereby ensuring its safe operation. In particular, the battery comprises an electrolyte with lithium salts and a novel diether compound with asymmetrical fluorination, developed based on electrolyte molecular design, synthesis and thermophysical properties characterization. The electrolyte with the asymmetrically fluorinated diether compound exhibits high thermal stability through high boiling point and high flash point, while also having a high working voltage, allowing high energy density designs and simultaneously optimizing operation safety by minimizing flammability and flash risks.

### CROSS-REFERENCE TO RELEVANT APPLICATION

The present application claims priority from a U.S. provisional patent application Ser. No. 63/548,807 filed Feb. 1, 2024, and the disclosures of which are incorporated by reference in their entireties.

### FIELD OF THE INVENTION

The present invention relates to an improved lithium metal battery. In particular, the lithium metal battery in the present invention is characterized by the electrolyte composition which comprises a novel asymmetrically fluorinated diether component of the electrolyte with high thermal stability and performance.

### BACKGROUND

In recent years, with the rapid development of science and technology, industries such as aerospace, new energy vehicles, high-speed rail, and large-scale energy storage grids have also ushered in a period of rapid development, and the requirements for energy storage equipment are also increasing. High energy density lithium metal batteries can meet people's requirements for energy storage devices with high energy density and high-power density. Lithium (Li) metal batteries have also become a research focus in recent years, in succession to lithium-ion batteries.

Ethers, such as 1,2-dimethoxyethane (DME) and 1,3-dioxolane (DOL) have emerged as a promising solvent system to achieve high coulombic efficiency up to 98% during lithium stripping and deposition. However, such symmetrical ethers solvent design is still suffering from poor oxidation stability, cycling instability and poor thermal stability.

Thus, there is a need to improve the LMB to with high performance while having a high thermal stability to withstand the more vigorous thermal runaway, hence preventing overheating and spark formation upon the occurrence of a short circuit. The present invention addresses this need.

### SUMMARY OF THE INVENTION

Addressing the above technical insufficiencies, the present invention provides a non-flammable lithium metal battery, characterized by its high flash point and high thermal stability, thereby ensuring its safe operation.

In one aspect, the present invention provides a high-voltage, high-flash point and thermally stable lithium metal battery comprising a positive electrode, a negative electrode, a separator placed between the two electrodes, and an electrolyte which comprises lithium salts and an asymmetrically fluorinated diether with the following molecular structure:

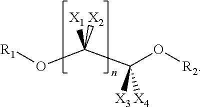

wherein n is any integer greater than 0; R₁ is selected from hydrogen, deuterium, halogen, C₁₋₁₀ alkyl, C₃₋₈ cycloalkyl, C₂₋₆ alkenyl, C₃₋₆ cycloalkenyl, C₅₋₇ heteroalkyl or C₂₋₆ alkyl ether; R₂ is selected from —CH₂CF₃, —CH₂CHF₂, —CH₂CH₂F, —CH₂OCH₃, —CH₂OCF₃, —CH₂OCH₂CH₃, —CH₂OCH₂CF₃, —CH₂OCF₂CF₃, —CH₂CF₃, —CF₂CF₃, —CH₂CF₂CF₃, —CF₂CF₂CF₃, —OCH₂CF₂CF₃ or —CH₂CH₂CF₃; and X₁ to X₄ are independently selected from hydrogen, deuterium, halogen, —CH₃, —CH₂CF₃, —CH₂CHF₂, —CH₂CH₂F, —CH₂OCH₃, —CH₂OCF₃, —CH₂OCH₂CH₃, —CH₂OCH₂CF₃, —CH₂OCF₂CF₃, —CF₂CF₃, —CH₂CF₂CF₃, —CF₂CF₂CF₃, —OCH₂CF₂CF₃ or —CH₂CH₂CF₃.

The high-voltage, high-flash point and thermally-stable lithium metal battery has a boiling point of no less than 100° C. and a flash point of no less than 100° C., while maintaining a high oxidation voltage of no less than 4.5 V. In addition, the asymmetrically fluorinated diether of the high-voltage, high-flash point and thermally-stable lithium metal battery may be formulated to have a lithium salt concentration of no higher than 4.5M.

In one embodiment, the lithium salts in the electrolyte of the high-voltage, high-flash point and thermally-stable lithium metal battery are selected from lithium bisfluorosulfonylimide, lithium bis (trifluoromethanesulfonyl) imide, lithium bis (oxalate) borate, lithium difluoro (oxalate) borate, lithium nitrate, or any combinations thereof.

In another embodiment, the high-voltage, the positive electrode of the high-flash point and thermally-stable lithium metal battery comprises an aluminium current collector with a coating comprising lithium cobalt oxide, lithium manganese oxide, lithium iron phosphate, lithium nickel manganese cobalt oxide, nickel rich lithium nickel manganese cobalt oxide, lithium nickel cobalt aluminium oxide, lithium cobalt phosphate, spinel lithium nickel manganese oxide, or any combinations thereof.

In other embodiment, the negative electrode of the high-voltage, high-flash point and thermally-stable lithium metal battery comprises a copper current collector coated with lithium metal.

In yet another embodiment, the separator of the high-voltage, high-flash point and thermally-stable lithium metal battery is selected from polyethylene separator, polypropylene separator, polytetrafluoroethylene separator, polyimide separator or a multilayer composite separator.

In a further embodiment, under a temperature of 150° C., the change in volume of the is no more than 10%.

In another further embodiment, upon penetration, the change in temperature of the high-voltage, high-flash point and thermally-stable lithium metal battery is no more than 5° C.

In other further embodiment, the high-voltage, high-flash point and thermally-stable lithium metal battery reaches a temperature of less than 100° C. upon impact of 300 N, and the increase in battery temperature due to the impact will be reduced to lower than 20% in a time period of 30 minutes after the time of impact.

### BRIEF DESCRIPTION OF THE DRAWINGS

FIG. 1 illustrates the oxidation pathway of conventional ether-based electrolytes

in lithium metal batteries.

FIG. 2 shows a comparison of lithium metal battery cell stability under different cutoff voltages.

FIG. 3 illustrates the relationship between the flammability and flash point of liquids.

FIG. 4 shows the structures of fluorinated ethers of the present invention and conventional non-fluorinated ethers.

FIG. 5 shows the results of linear sweep voltammetry (LSV) scanning of ethers with and without fluorination.

FIG. 6 shows the comparison of C rate performance between G2 and fluorinated G2-based ethers.

FIG. 7 shows the comparison of C rate performance between DME and fluorinated DME ethers.

FIG. 8 shows the C rate performance of fluorinated ether #7 (NAMI-130, DEE-CF₃ with 2M LiFSI) and fluorinated ether #8 (NAMI-140-2, DEE-CF₂H with 2M LiFSI), in comparison with DEE with 3M LiFSI.

FIG. 9 shows the C rate performance of fluorinated ether #8 (NAMI-140-2, DEE-CF₂H) under different concentrations of lithium salt (2M/3M LiFSI respectively).

FIG. 10 shows the cycling performance of #5 (NAMI-120, DME-CF2H), #7 and #8 electrolytes under 3-4.5V 1C/1C cycling.

FIG. 11 shows cycling performances of non-fluorinated DMP in milliampere-hour level cell using 3M LiFSI salt, and #19 electrolytes in milliampere-hour level cell using 2M LiFSI salt, wherein the fluorinated ether #19 in the electrolyte has the below chemical formula:

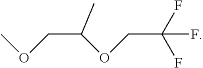

FIG. 12 shows cycling performance of #14 and #20 electrolytes in comparison with a non-fluorinated ether electrolyte, under 3-4.5V 0.5C/0.5C cycling, wherein the fluorinated ether #14 has the below chemical formula:

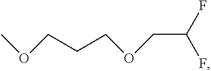

and the fluorinated ether #20 has the below chemical formula:

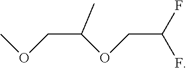

FIG. 13 shows the formation of the 0.5C cycling cell, to be subjected to nail penetration test, heat box test and impact test.

FIG. 14 shows the 150° C. hot box test result of the above-mentioned 0.5° C. cycling cell, the change in open-circuit voltage and battery temperature along with the change in the environment temperature.

FIG. 15 shows the discharge process by the above-mentioned 0.5C cycling cell upon nail penetration.

FIG. 16 shows the nail penetration test results of the above-mentioned 0.5C cycling cell, including the change in battery temperature and open-circuit voltage.

FIGS. 17A and 17B shows the impact test results of the above-mentioned 0.5C cycling cell, including the change in battery temperature (FIG. 17A) and open-circuit voltage (FIG. 17B).

FIGS. 18A, 18B and 18C show the comparisons of the discharge capacities of the fluorinated ethers of the present invention, with a comparison to the non-fluorinated ether counterparts. FIG. 18A shows the comparisons of the C-rate test results of the fluorinated ether #5 and non-fluorinated DME ether; FIG. 18B shows the comparison of the C-rate test results of the fluorinated ethers #7 and #8 and non-fluorinated DEE ether; and FIG. 18C shows the comparison of the C-rate test results of the fluorinated ether #5, #14, #19 and #20. All the above-mentioned ethers are under a LiFSI salt concentration of 2M.

FIGS. 19A and 19B showcase the cycling performances of the electrodes utilizing the fluorinated ethers of the present invention. FIG. 19A shows the cycling performance of the fluorinated ether #14 under 3-4.3V; and FIG. 19B shows the cycling performance of the fluorinated ether #19 under 3-4.5V.

### DETAILED DESCRIPTION

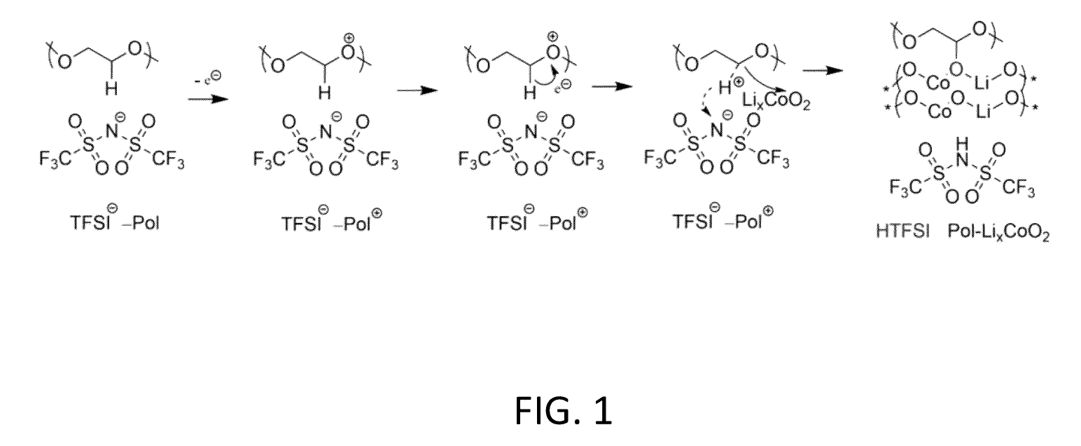

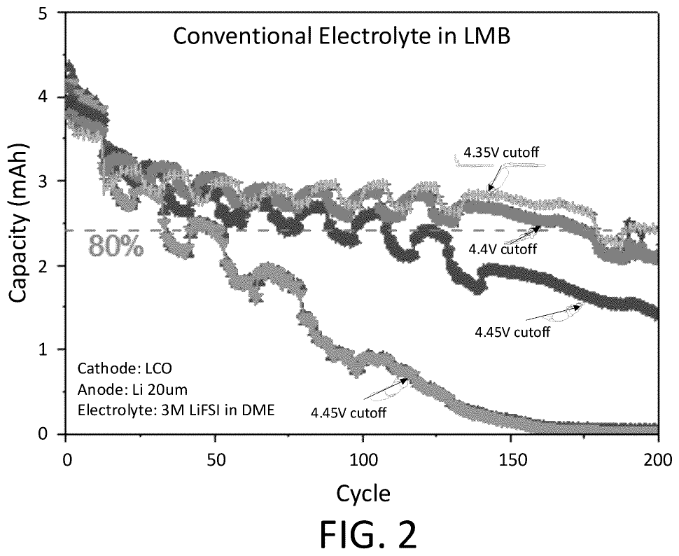

Conventional 1-2M ethers cannot be directly applied on Ni-rich cathode or other lithium metal oxide cathode with high operating windows (>4.5V) as the oxidation stability of those ether failed to prevent the irreversible interaction between oxygen atom and cathode materials as shown in FIG. 1. With elevated cutoff voltage, the capacity retention tumbles after 50 cycles at 4.5V as shown in FIG. 2.

High salt concentration in the electrolyte can help to decrease the proportion of free, reactive solvent leading to improved high voltage resistance and cycling stability off lithium metal battery. Unfortunately, the solvent-in-salt electrolytes system sacrifices viscosity, ionic conductivity and present a high cost. As shown in Table 1, there is a 34-fold increase in viscosity from 1M to 3M LiTFSI in DME with nearly one-fifth of its original conductivity.

TABLE 1
Viscosity and ionic conductivity of conventional DME-
based electrolyte with different salt concentrations

| | Viscosity (cP) | Conductivity (mS cm⁻¹) |
|---|---|---|
| Electrolyte | @25° C. | @30° C. |
| 1M LiTFSI in DME | 1.76 | 12.99 |
| 1M LiDFOB in DME | 1.46 | 11.85 |
| 0.5M LiTFSI + | 1.30 | 12.14 |
| 0.5M LiDFOB in DME | | |
| 3M LiTFSI in DME | 60 | 2.43 |
| 4M LiDFOB in DME | 118 | 1.99 |
| 2M LiTFSI + | 51 | 2.31 |
| 2M LiDFOB in DME | | |

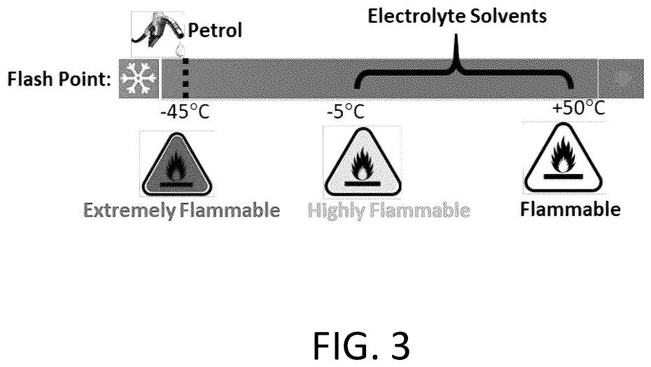

Due to the extremely high reactivity and energy density of lithium metal anode, the thermal runaway is much more vigorous than in lithium-graphite anode (LiC₆). Therefore, the safety issue would be a key to make lithium metal batteries (LMB) practical for real applications. Conventional ether-based electrolyte for LMB, such as DME, has a low flash point close to 0° C. The flash point of a material is the lowest liquid temperature at which, under certain standardized conditions, a liquid gives a vapor pressure that could form an ignitable air mixture. An explosion could trigger by a spark upon battery short circuit. As shown in FIG. 3, the lower the flash point, the higher the flammability of the liquid.

In addition, despite further progress in incorporating fluorinated diethers into electrolytes, the fluorinated diethers in the art are symmetrical, the structure of which leads to more rigid molecular framework and even electron distribution This may in turn hinder the molecular stability under high-voltage conditions as the efficiency of energy dissipation may not be sufficient to protect the diethers from breaking down in such high energy states.

Additionally, the symmetrical arrangement of the diethers may result in stronger intermolecular interactions and resulting in higher viscosity. Under high voltage circumstances, the ionic mobility may be hindered by the high viscosity of the electrolyte with symmetrical diethers, giving rise to localized high-energy regions, increasing the likelihood of electrolyte instability and thermal runaway.

The lithium metal battery in the present invention, in view of the above problems, is characterized by the electrolyte composition which comprises a novel asymmetrically fluorinated diether component of the electrolyte with high thermal stability and performance, without the necessity of a high-salt concentration environment which may in turn compromise the conductivity or viscosity of the electrolyte.

The lithium metal battery of the present invention comprises a positive electrode, a negative electrode, a separator separating the two electrodes, and an electrolyte which comprises lithium salts and a specifically formulated diether with the below structure:

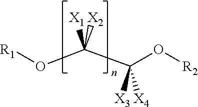

Specifically, R₁ is selected from hydrogen, deuterium, halogen, C₁₋₁₀ alkyl, C₃₋₈ cycloalkyl, C₂₋₆ alkenyl, C₃₋₆ cycloalkenyl, C₅₋₇ heteroalkyl or C₂₋₆ alkyl ether; R₂ is selected from —CH₂CF₃, —CH₂CHF₂, —CH₂CH₂F, —CH₂OCH₃, —CH₂OCF₃, —CH₂OCH₂CH₃, —CH₂OCH₂CF₃, —CH₂OCF₂CF₃, —CH₂CF₃, —CF₂CF₃, —CH₂CF₂CF₃, —CF₂CF₂CF₃, —OCH₂CF₂CF₃ or —CH₂CH₂CF₃.

The above selection of functional groups of R₁ and R₂ as listed above is an essential feature of the novel electrolyte component, which is diether with asymmetric fluorination, with only one of the two side chains of the diether being fluorinated.

Further, X₁ to X₄ are independently selected from hydrogen, deuterium, halogen, —CH₃, —CH₂CF₃, —CH₂CHF₂, —CH₂CH₂F, —CH₂OCH₃, —CH₂OCF₃, —CH₂OCH₂CH₃, —CH₂OCH₂CF₃, —CH₂OCF₂CF₃, —CF₂CF₃, —CH₂CF₂CF₃, —CF₂CF₂CF₃, —OCH₂CF₂CF₃ or —CH₂CH₂CF₃.

In the asymmetrically fluorinated diether compound, the number of repeating units n could be any integer greater than 0.

The above novel asymmetric fluorinated diether structure is designed and synthesized based on thermophysical properties characterization, which allows the electrolyte to demonstrate significant thermal stability and non-flammability under conventional battery usage and operation, with a boiling point of no less than 100° C. and a flash point of no less than 100° C.

The novel asymmetric fluorinated diether-comprising electrolyte also has a high oxidation voltage of no less than 4.5 V, which is essential in supporting high-energy density designs without compromising safety due to electrolyte breakdown under high operating voltages.

Apart from the above asymmetrically fluorinated diether, the electrolyte in the lithium metal battery in the present invention further comprises lithium salts, which are selected from lithium bisfluorosulfonylimide, lithium bis (trifluoromethanesulfonyl) imide, lithium bis (oxalate) borate, lithium difluoro (oxalate) borate, lithium nitrate, or any combinations thereof.

The positive electrode of the high-flash point and thermally-stable lithium metal battery comprises an aluminium current collector with a coating comprising lithium cobalt oxide, lithium manganese oxide, lithium iron phosphate, lithium nickel manganese cobalt oxide, nickel rich lithium nickel manganese cobalt oxide, lithium nickel cobalt aluminium oxide, lithium cobalt phosphate, spinel lithium nickel manganese oxide, or any combinations thereof.

The negative electrode of the high-voltage, high-flash point and thermally-stable lithium metal battery comprises a copper current collector coated with lithium metal.

Meanwhile, the separator of the high-voltage, high-flash point and thermally-stable lithium metal battery is selected from polyethylene separator, polypropylene separator, polytetrafluoroethylene separator, polyimide separator or a multilayer composite separator.

### EXAMPLES

### Example 1

### Characteristics of the Developed Asymmetrically Fluorinated Diethers

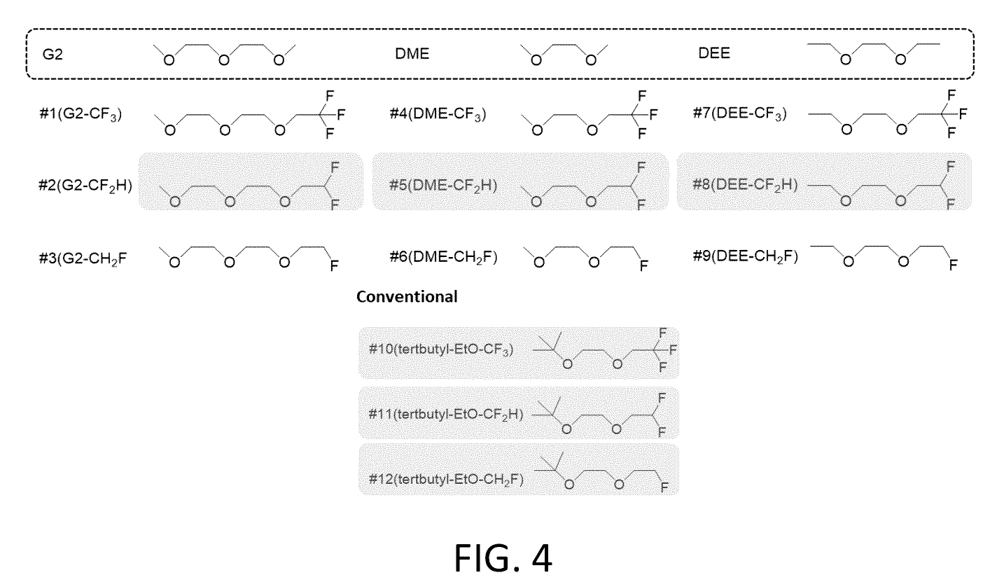

A series of asymmetrically fluorinated ethers are developed, the structures of which are shown in FIG. 4. The thermophysical and electrochemical properties are significantly improved as summarized in Table 2 below. In comparison to their parent molecules, the fluorinated ethers have shown a 10°° C. increase in boiling point and >60° C. flash point improvement simultaneously.

TABLE 2
Summary of the developed asymmetrically fluorinated diethers:

| | | #1 | #2 | | #4 | #5 | | #7 | #8 |
|---|---|---|---|---|---|---|---|---|---|
| | | (G2- | (G2- | | (DME- | (DME- | | (DEE- | (DEE- |
| Properties | G2 | CF₃) | CF₂H) | DME | CF₃) | CF₂H) | DEE | CF₃) | CF₂H) |
| Boiling | 162 | 170- | 180- | 85 | 112 | 124 | 122 | 130- | 142- |
| point (° C.) | | 172 | 185 | | | | | 132 | 144 |
| Flash point | 57 | No | No | −2 | No | No | 35 | No | No |
| (° C.) | | flash | flash | | flash | flash | | flash | flash |
| | | @170 | @180 | | @120 | @130 | | @100 | @140 |
| SET (s/g) | >20 | <6 | <6 | >20 | <6 | <6 | >20 | <6 | <6 |
| Freezing | −64 | TBC | TBC | −58 | TBC | TBC | −74 | <−60 | <−60 |
| point (° C.) | | | | | | | | | |
| Absolute | 0.95 | TBC | 2.4 | 0.42 | TBC | TBC | TBC | 0.8 | 1.1 |
| viscosity | | | | | | | | | |
| (cP) | | | | | | | | | |
| LSV | 5.28 | 5.35 | 5.56 | 5.18 | 5.56 | 5.62 | 5.45 | 5.85 | 5.65 |
| oxidation | | | | | | | | | |
| peak (onset, | | | | | | | | | |
| 2M LiFSI, | | | | | | | | | |
| V) | | | | | | | | | |
| Ionic | 9.58 | 3.88 | 3.75 | 10 | TBC | 5.5 | TBC | 2.24 | 4.72 |
| conductivity | | | | | | | | | |
| (mS/cm, | | | | | | | | | |
| 1M LiFSI) | | | | | | | | | |
| Ionic | 8.02 | 3.65 | TBC | TBC | TBC | TBC | TBC | TBC | TBC |
| conductivity | | | | | | | | | |
| (mS/cm, | | | | | | | | | |
| 2M LiFSI) | | | | | | | | | |

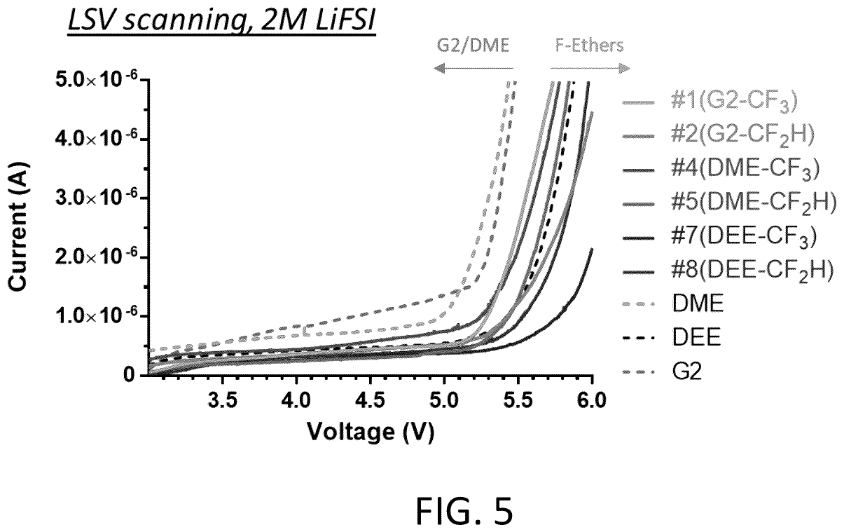

As shown in FIG. 5, the asymmetric fluorinated ethers have shown delayed oxidation onset voltage (>5.2V) in comparison to the parent G2 and DME. For DEE derivatives (#7 and #8), the oxidation voltage also improved by 0.2-0.4V. Suggesting a higher stable voltage operation window. The LSV result is tabulated in Table 3 below.

TABLE 3

| Electrolyte (2M | Major oxidation | Current at | Current at | Current at |
|---|---|---|---|---|
| LiFSI) | peak onset (V) | 5.0 V (A) | 5.5 V (A) | 6.0 V (A) |
| DME | 5.18 | 1.06E−06 | 6.39E−06 | 2.41E−05 |
| DEE | 5.45 | 5.54E−07 | 1.26E−06 | 7.90E−06 |
| G2 | 5.28 | 1.37E−06 | 5.42E−06 | 1.76E−05 |
| #1 (G2-CF₃) | 5.30 | 5.20E−07 | 2.53E−06 | 7.80E−06 |
| #2 (G2-CF₂H) | 5.56 | 5.27E−07 | 1.24E−06 | 4.47E−06 |
| #4 (DME-CF₃) | 5.56 | 7.48E−07 | 2.16E−06 | 9.12E−06 |
| #5 (DME-CF₂H) | 5.62 | 4.06E−07 | 1.31E−06 | 8.50E−06 |
| #7(DEE-CF₃) | 5.65 | 3.84E−07 | 5.70E−07 | 2.15E−06 |
| #8 (DEE-CF₂H) | 5.85 | 4.48E−07 | 9.08E−07 | 5.59E−06 |

It could be observed from Table 1 that fluorinated ethers in general have better performances than their parent molecules, DME and G2, in LSV scanning, which suggests a possible higher voltage operating window.

It is further observed that there is a higher overall oxidation stability in electrolytes with higher fluorination degrees.

### Example 2

### Battery Performance

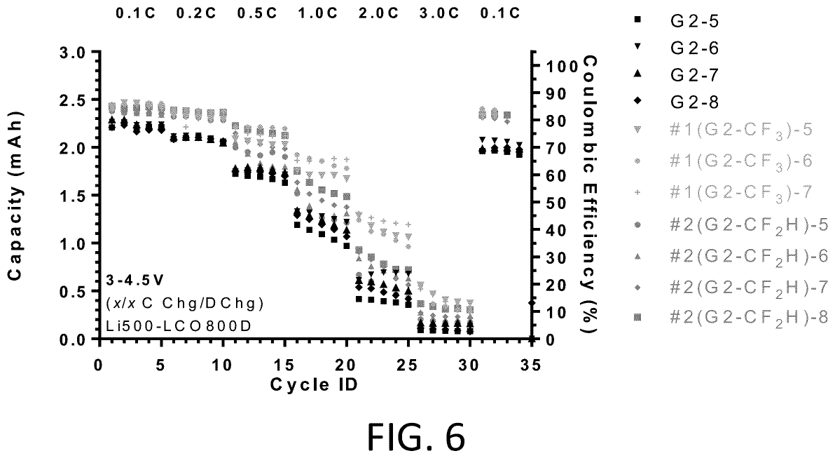

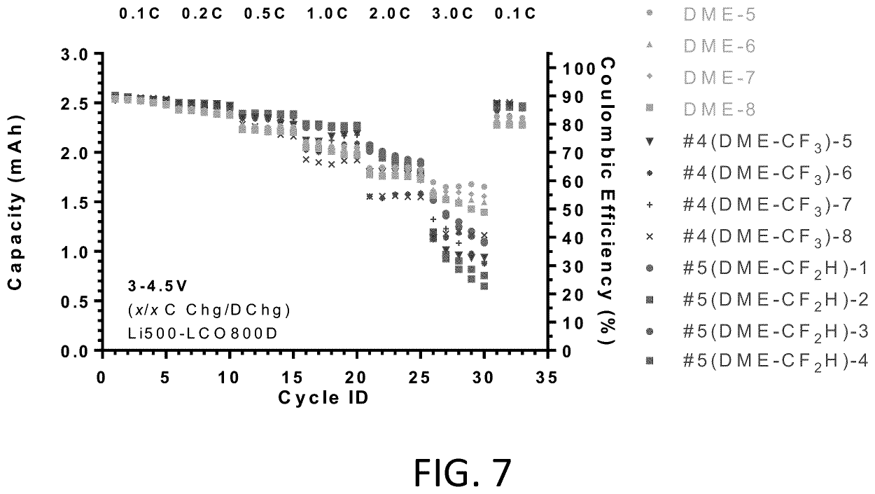

The battery performance is firstly studied in coin cell using LCO cathode. As shown in FIG. 6, the fluorinated #1 and #2 electrolytes have shown better retention percentages in comparison to G2 from 0.1C to 3.0C charge-discharge cycles. Similar trend is observed for DME and fluorinated DME derivatives from 0.1C to 2.0C as shown in FIG. 7. It is worth to note that the fluorinated ethers have shown a retention recovery up to 97% after C rate test, and which is significantly higher than the recovery of the coin cells using the non-fluorinated parent G2 and DME based electrolytes. This result suggests that the asymmetric fluorinated ethers above all can provide comparable rate performance, also promote more efficient electrochemistry reactions and minimal side reaction within the battery. The result is tabulated in Table 4 below.

TABLE 4

| 3-4.5 V | 2M LiFSI Average retention % w.r.t. 0.1 C | | | | | | | |
|---|---|---|---|---|---|---|---|---|
| Chg/DChg | | #1 | #2 | | #4 | #5 | #7(DEE- | #8 |
| C | G2 | (G2-CF₃) | (G2-CF₂H) | DME | (DME-CF₃) | (DME-CF₂H) | CF₃) | (DEE-CF₂H) |
| 0.2 C | 93.30% | 97.23% | 97.06% | 95.86% | 97.85% | 96.56% | 97.69% | 98.18% |
| 0.5 C | 77.28% | 88.52% | 83.41% | 88.99% | 90.71% | 91.82% | 93.38% | 94.37% |
| 1.0 C | 53.40% | 75.26% | 59.50% | 81.17% | 81.23% | 85.60% | 88.35% | 89.49% |
| 2.0 C | 23.44% | 48.18% | 28.89% | 71.75% | 65.83% | 72.68% | 80.31% | 81.82% |
| 3.0 C | 5.21% | 16.95% | 10.09% | 62.36% | 42.72% | 43.27% | 70.24% | 72.23% |
| 0.1 C | 89.61% | 97.13% | 96.04% | 91.79% | 97.21% | 97.23% | 97.73% | 98.41% |

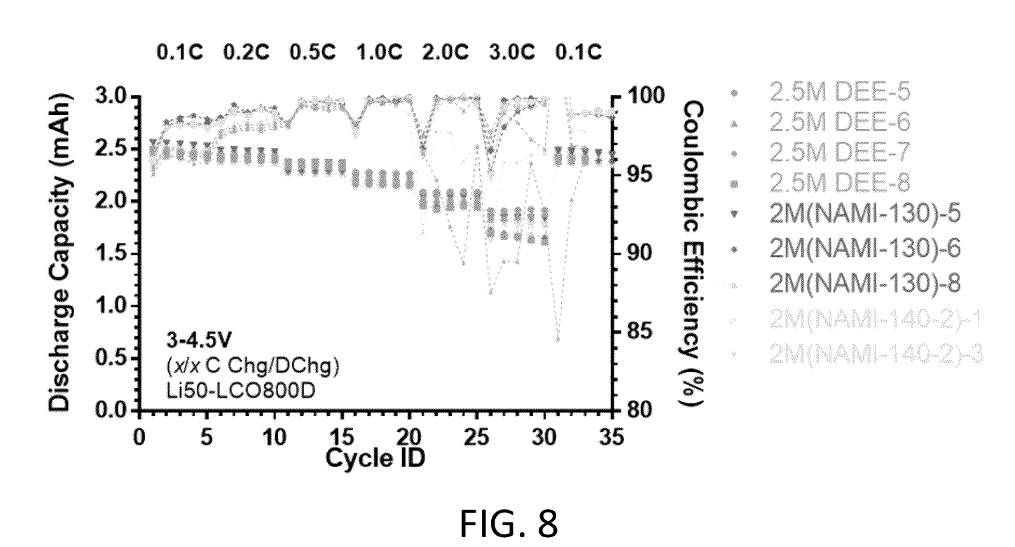

For DEE C rate performance, as shown in FIG. 8, the fluorinated derivatives #7 (NAMI-130) and #8 (NAMI-140-2) have shown a comparable retention capacity and better coulombic efficiency with 2M LiFSI in comparison to 2.5M DEE.

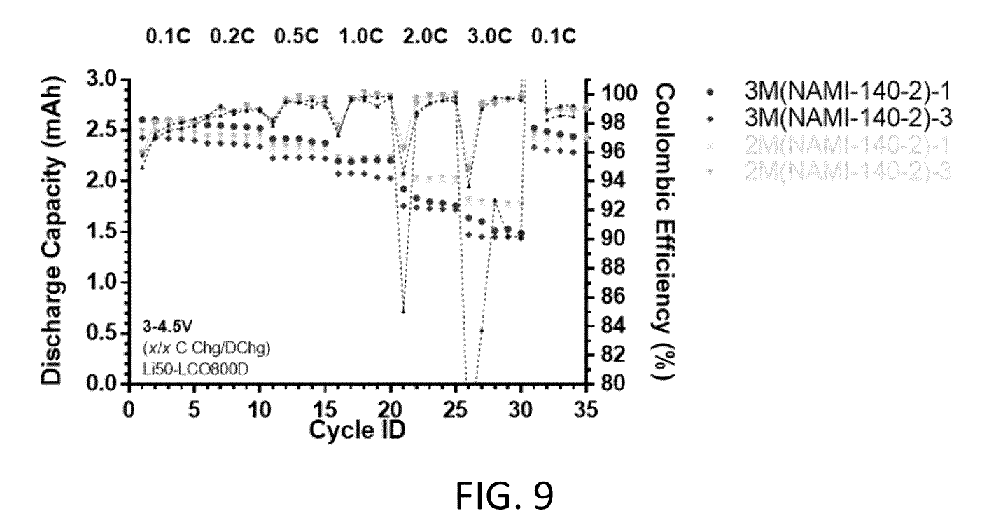

It should be further noted that, with reference to FIG. 9, the performance of fluorinated derivative #8 (NAMI-140-2) is better in a lower lithium salt concentration, which may be due to a change in ionic conductivity or viscosity. Therefore, there is a potential of using a lower salt concentration without sacrificing retention or coulombic efficiency, which could be advantageous in terms of offsetting the growing demand and thus the price increase of lithium salts.

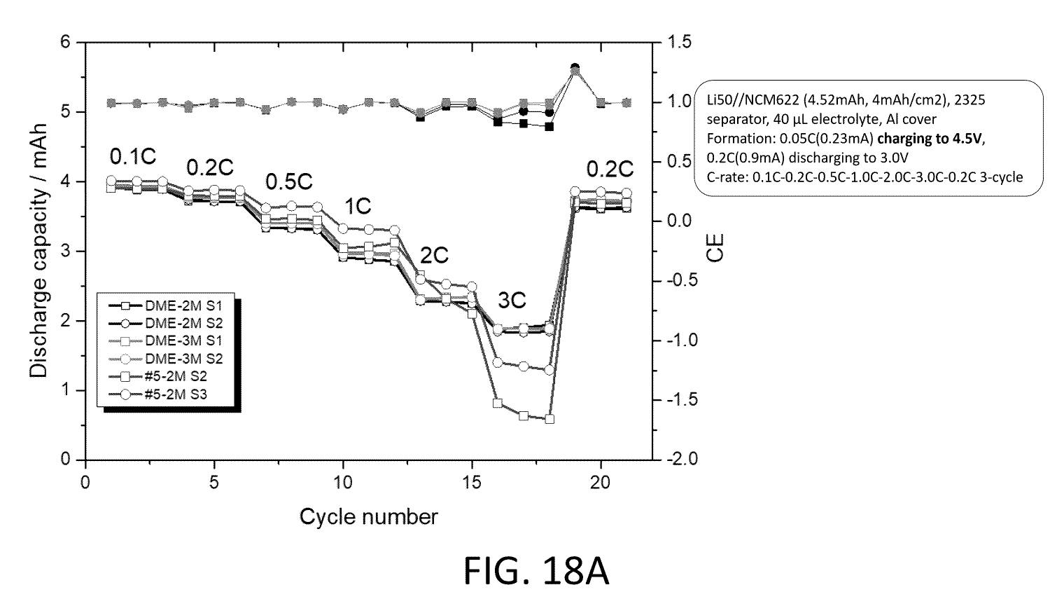

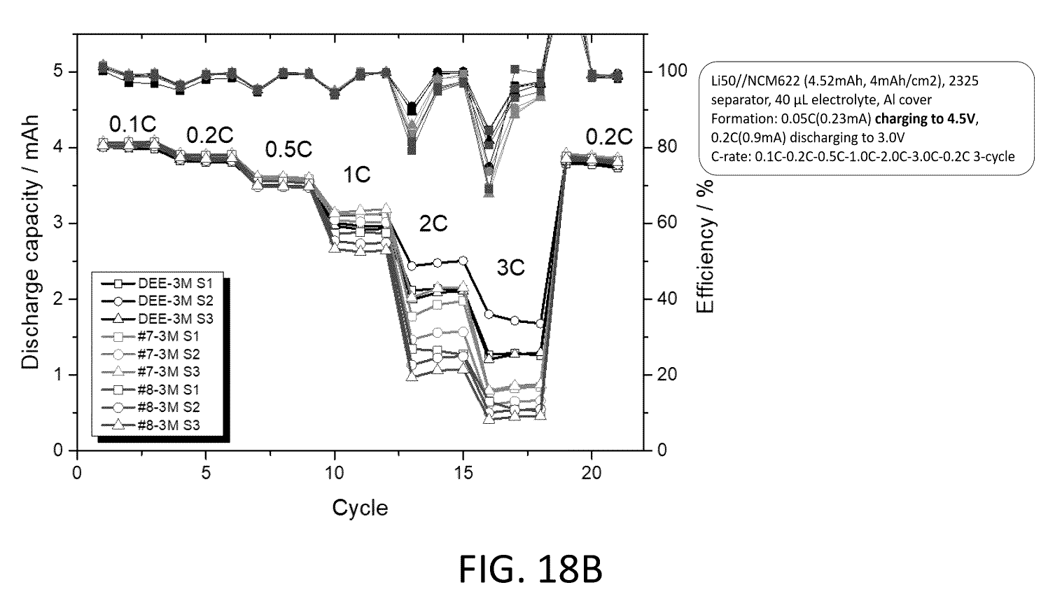

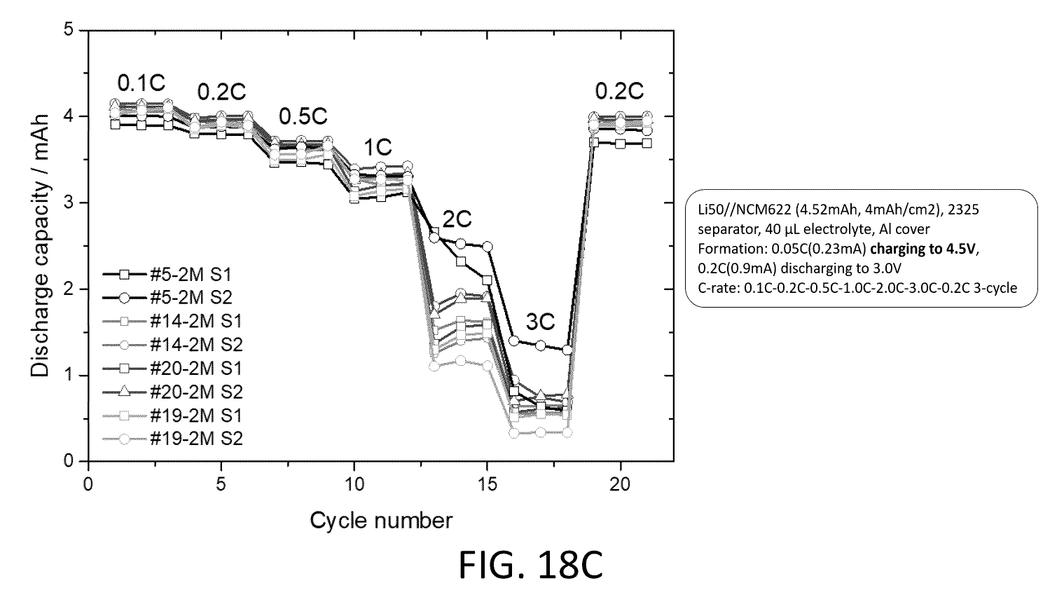

With reference to FIGS. 18A to 18C, it can be observed that all the fluorinated ethers of the present invention have a comparable performance, or outperform the non-fluorinated ethers in coulombic efficiencies under lower charging-discharging rates, particularly from 0.1C to 1C.

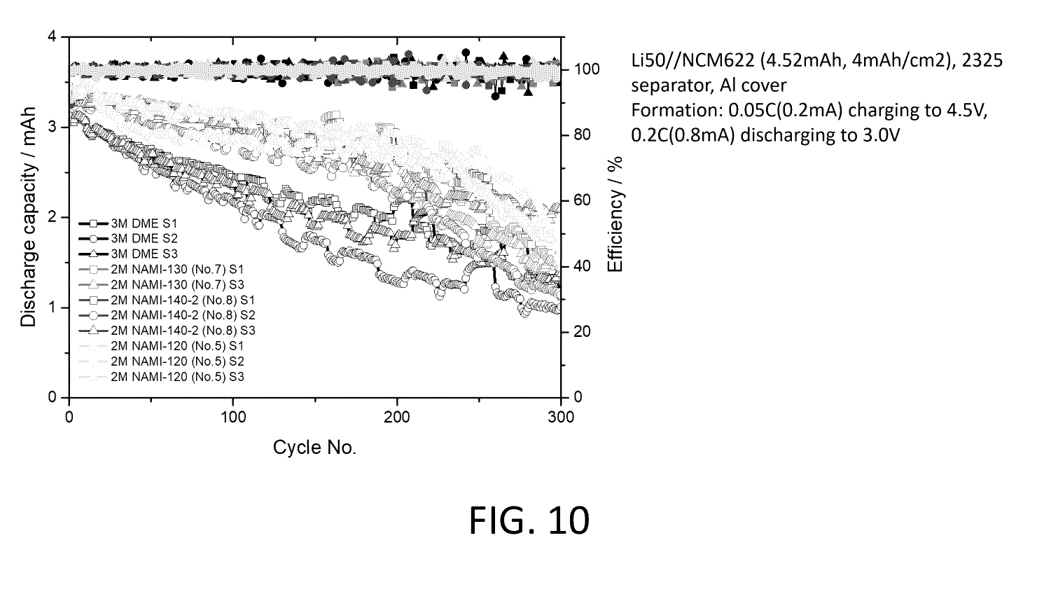

Cycling performance of as-developed electrolytes have been verified on NCM-622 cathode with 4.5 V cutoff voltage as shown in FIG. 10. In comparison to the state-of-art 3M DME electrolyte (80% retention after 50 cycles), the fluorinated ether could maintain a capacity retention up to 80% after 200 cycles.

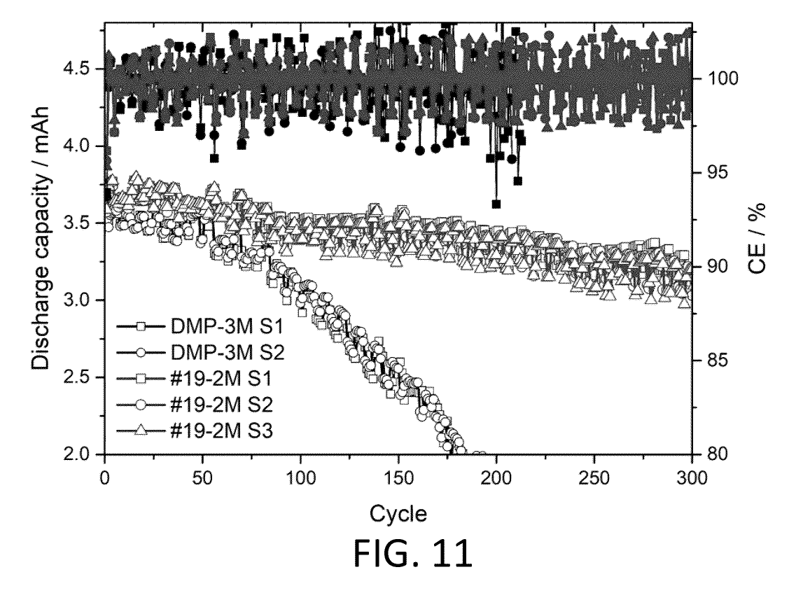

It should also be noted that a similar trend has been observed for DMP in milliampere-hour level cell using 3M LiFSI salt and #19 electrolyte in milliampere-hour level cell using 2M LiFSI salt as shown in FIG. 11. The fluorinated ether #19 electrolyte successfully achieved a retention percentage of 85% after 300 cycles while the retention for DMP drops after 100 cycles with significant overcharging. It is worth noting that the results suggest that the fluorinated ethers of the present invention are capable of outperforming traditional non-fluorinated ethers even under a lower salt concentration, meaning a reduced salt usage needed and ultimately lowered costs.

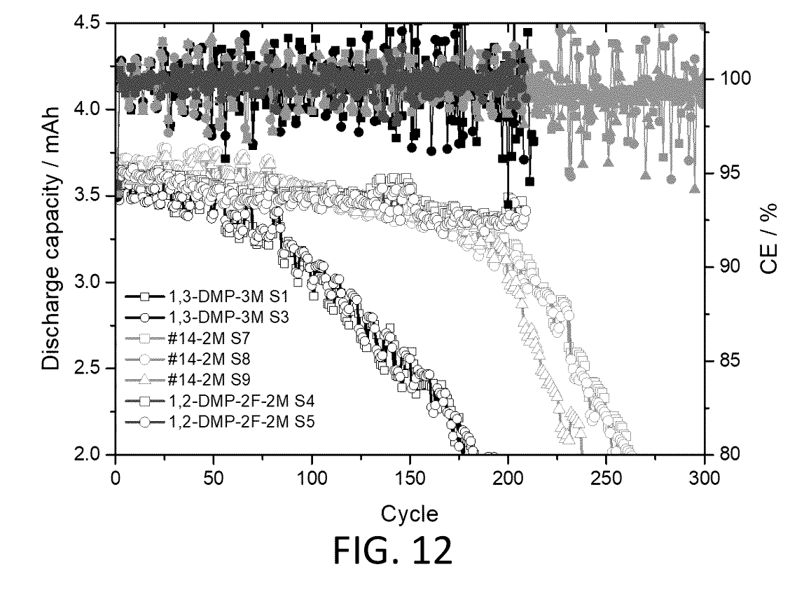

Also, referring to FIG. 12, it can be observed that in comparison with the non-fluorinated ether electrolyte (1,3-DMP-3M S1 and 1,3-DMP-3M S3), the electrolytes with fluorinated ethers display a significant improvement in cycling stability, particularly from 100 cycles onwards.

Therefore, as observed in FIGS. 10-12, a conclusion can be drawn that the fluorination of the ethers induces significant improvements in cycling stability, particularly from around 100 to 350 cycles.

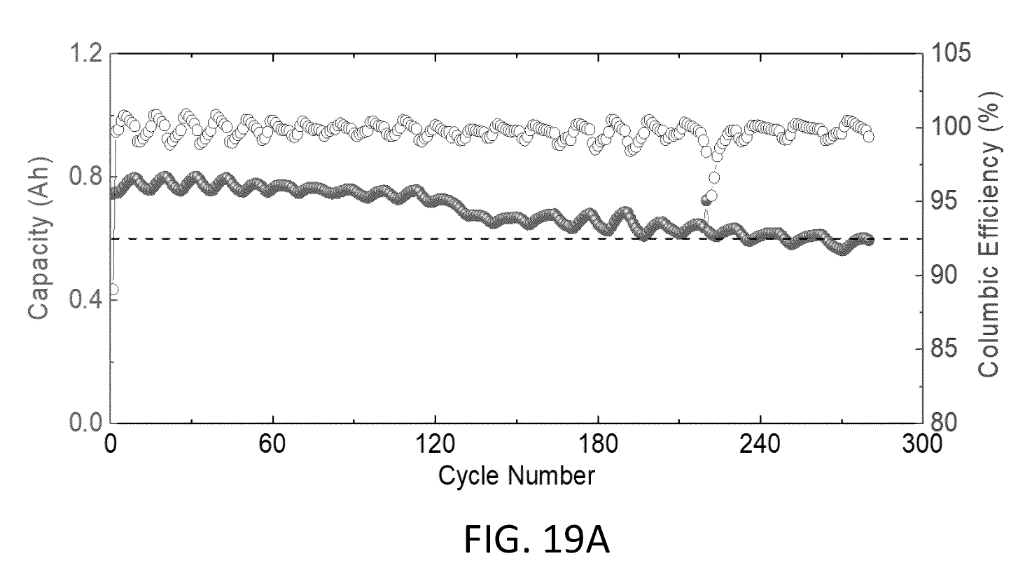

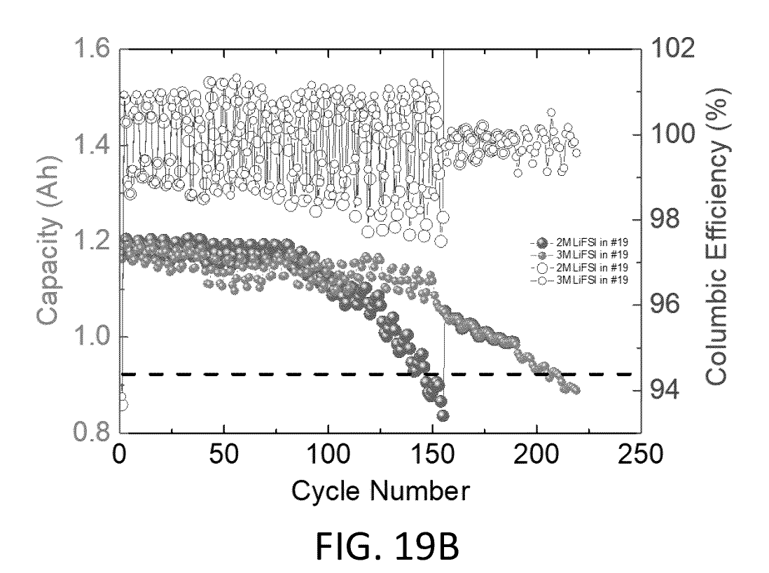

Further results also suggest that under sub-Ah level, the cycling performance after long cycling by the fluorinated ethers of the present invention are retained at a high level. With reference to FIGS. 19A and 19B, both electrolytes utilizing fluorinated ethers #14 and #19 respectively are subjected to sub-Ah level long cycling tests. The components of the electrolytes are as Table 5 below:

TABLE 5

| | | | | Electrolyte | |
|---|---|---|---|---|---|
| | | | | Amount | |
| Anode | Cathode | Separator | Electrolyte | (mL) | Test |
| Li50@NA | NMC-622 | Aramid@PE | 3M in | 6 | 3-4.3 V |
| MI-NF | | | LiFSI in | | 0.1 C × 2, |
| (30) | | | #14 | | 1 C long |
| | | | | | cycling |
| Li50 | NMC-622 | MST-20 + 4 | 2M in | 6 | 3-4.5 V |
| | | | LiFSI in | | 0.1 C × 2, |
| | | | #19 | | 0.1 C FC, |
| | | | | | 0.5 C |
| | | | | | cycling |
| Li50 | NMC-622 | MST-20 + 4 | 3M in | 6 | 3-4.5 V |
| | | | LiFSI in | | 0.1 C × 2, |
| | | | #19 | | 0.1 C FC, |
| | | | | | 0.5 C |
| | | | | | cycling |

It can be observed in FIG. 19A that the fluorinated ether #14 retains a coulombic efficiency of around 80% after 275 cycles; and similarly in FIG. 19B, the fluorinated ether #19 retains a coulombic efficiency of around 80% after 200 cycles.

Further, tests are conducted to investigate the safety of the batteries with fluorinated ether electrolyte of the present invention. Table 6 below is the components of the 0.5C cycling cell produced with the fluorinated ether electrolyte of the present invention, to be subjected to safety tests.

TABLE 6

| | | | | Electro- | |
|---|---|---|---|---|---|
| | | | | lyte | |
| Anode | Cathode | Separator | Electrolyte | amount | Tests |
| Li50 | 811 | PE-8 + 3, | 4.5M LiFSI | 4 mL | 0.1 C × 2, |
| | | Ebeam150kGy | in #14 | | 0.1 C FC, |
| | | | (fluorinated | | (i) nail |
| | | | 1,3-DMP) | | penetration; |
| | | | | | (ii) 150° C.; |
| | | | | | (iii) impact |

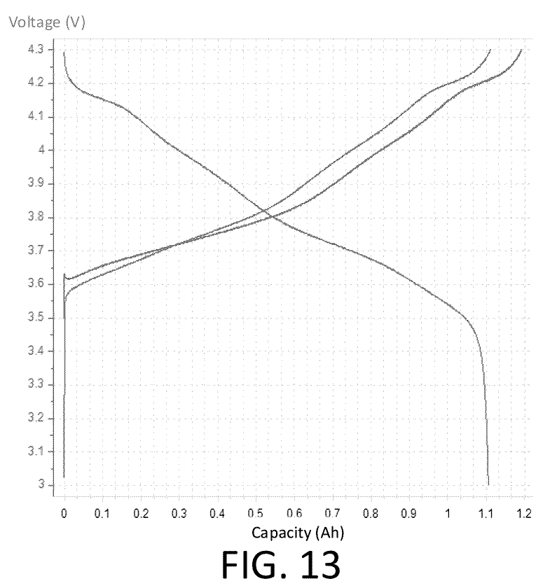

FIG. 13 shows the formation of the 0.5C cycling cell with the components stated in Table 5 above.

Three sets of hot box tests are conducted to test the thermal runaway, or lack thereof, of the batteries of the present invention. The first test involves five fully charged samples. After stabilization for 1 h and 4 h, respectively, at the ambient temperature of highest test temperature and lowest test temperature, as specified in cell spec, cells are charged by using the upper limit charging voltage and maximum charging current, until the charging current is reduced to 0,05 It A, using a constant voltage charging method.

The batteries, fully charged using the above-mentioned method, are heated in a gravity convention or circulating air oven. The temperature of the oven is raised at a rate of 5° C.±2° C. per minute until a temperature of 150° C.±2° C. and remained at the temperature level for 10 minutes. The samples are then allowed to cool down to room temperature of 20° C.±5° C. for further examination. Results suggest no thermal runaway across all samples, causing no fire or explosion.

Further, five additional batteries are charged, after stabilization for 1 h and 4 h, respectively, at the ambient temperature of highest test temperature and lowest test temperature, as specified in cell spec, by using the upper limit charging voltage and maximum charging current, until the charging current is reduced to 0.05 It A, using a constant voltage charging method. These five charged batteries are heated in a gravity convention or circulating air oven. The temperature of the oven is raised at a rate of 5° C.±2° C. per minute until a temperature of 150° C.±2° C. and remained at the temperature level for hour. By the termination of the test, the samples are observed to not have caused any fire or explosion.

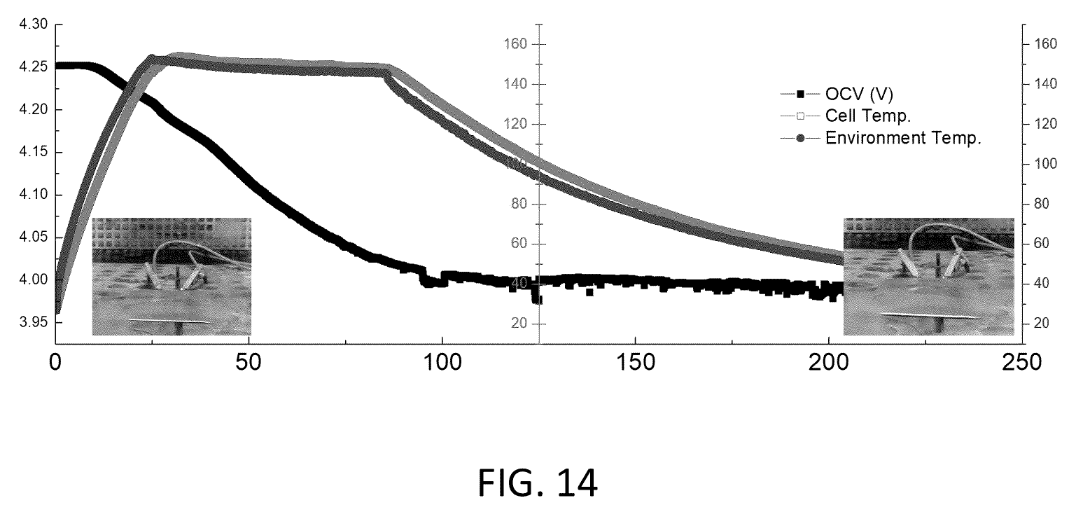

One more battery is fully charged through the charging method described in paragraph above, and is placed in gravity or circulating air convection oven at an ambient temperature of 20° C.±5° C. for 1 hour, and the temperature is subsequently raised at a rate of 5° C.±2° C. per minute until a temperature of 145° C.±2° C. and remained at the temperature level for 60 minutes. As observed in FIG. 14, the battery maintained high stability even under a higher temperature in a longer time period in the hot box test without occurrence of thermal runaway. The photographs on the right, showing the battery cell after the hot box test, demonstrates a volume expansion of less than 10% as compared to that before the hot box test, evidencing that the battery of the present invention possesses remarkable thermal stability.

As observed in FIG. 14, the battery maintained high stability under a temperature of 150° C. in the hot box test without occurrence of thermal runaway. The photographs on the right, showing the battery cell after the hot box test, demonstrates a volume expansion of less than 10% as compared to that before the hot box test in, shown in the photograph on the left.

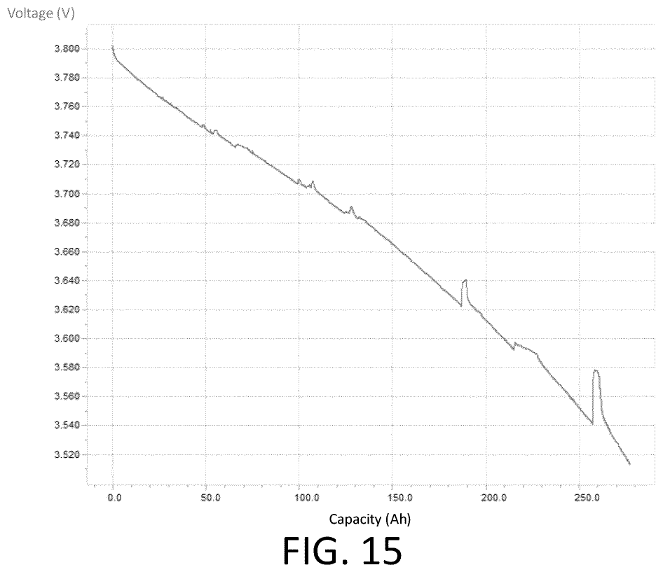

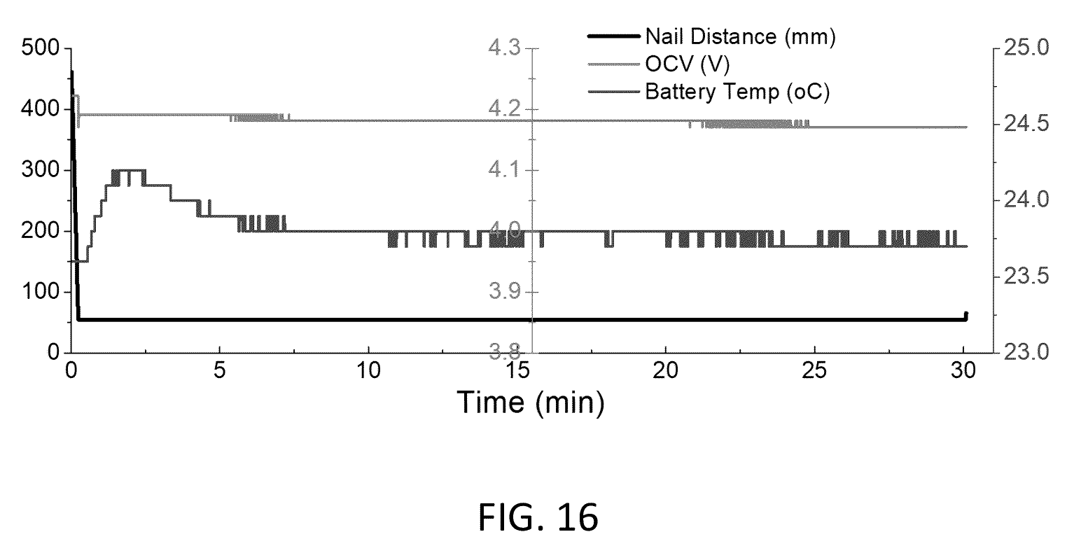

In a nail penetration test, the battery cell prepared according to Table 5 demonstrates a change in battery temperature of less than 1° C. upon full penetration by a nail (as shown in FIG. 16), and stable discharge is observed (FIG. 15).

The nail penetration test involves driving a metallic alloy nail with a diameter of 3 mm through the fully charged lithium battery of the present invention at a prescribed speed of 5 mm/s. No fire or explosion is caused across all samples subjected to the nail penetration test.

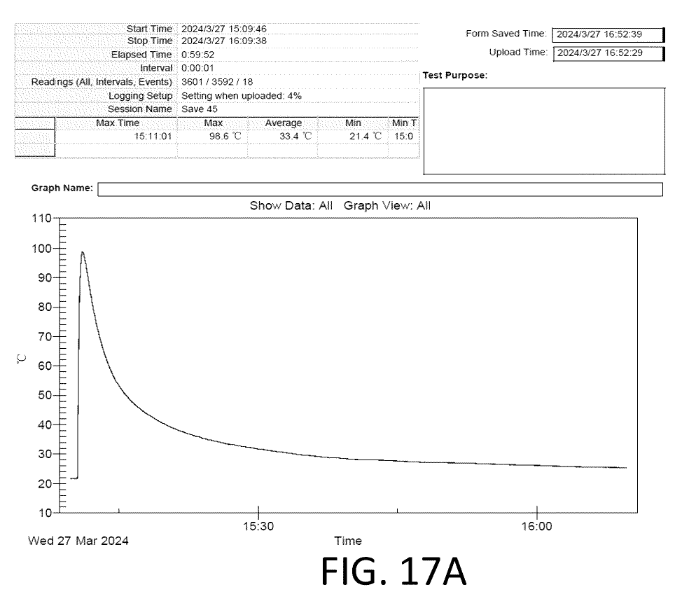

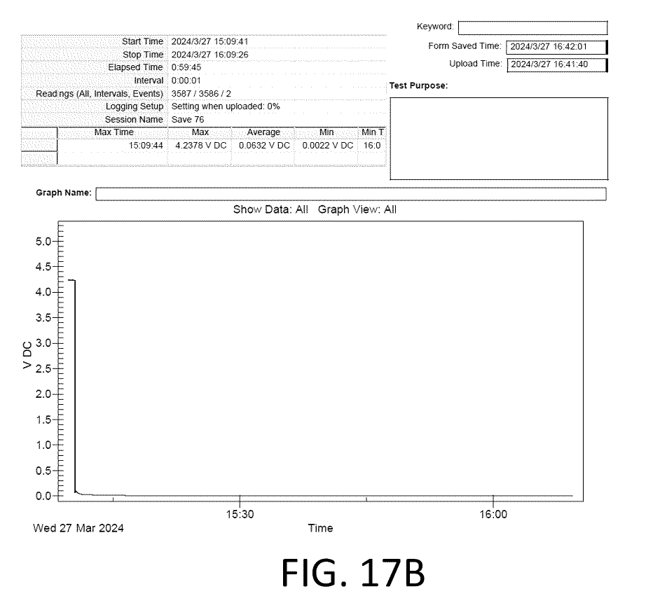

FIGS. 17A and 17B are the results of the impact test carried out on the battery cell prepared according to Table 5.

The impact test involves five lithium battery cells of the present invention, fully charged at upper limit charging voltage and maximum charging until the charging current is reduced to 0.05 C A, which are placed with a bar of 15.8±0.1 mm diameter across the centre and impacted with a 9.1±0.46 kg weight dropped from a height of 610±25 mm.

For a cylindrical cell, the impact test is conducted with the bar perpendicular to the longitudinal axis of the battery. For a prismatic cell, the impact test is also conducted with bar perpendicular to the cell, and further repeated with 90-degree rotation such that both the wide and narrow sides are subjected to the impact test.

While the temperature of the battery rises to 98.6° C. shortly after an impact of 300 N, the battery temperature quickly cools off and, by the time of 30 minutes after the impact, the rise in temperature due to the impact is already reduced to less than 20%. Again, no fire or explosion is caused after impact across all samples subjected to the test.

The tests above demonstrate significant electrical and thermal stability of the battery cell of the present invention even under mechanical damages and extreme conditions such as high temperature, therefore proving its safety for use over a wide variety of applications.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A high-voltage, non-flammable and thermally-stable lithium metal battery, comprising:
a positive electrode;
a negative electrode;
a separator placed between the positive electrode and the negative electrode; and
an electrolyte comprising lithium salts and asymmetrically fluorinated diethers;
wherein the asymmetrically fluorinated diethers have the following molecular structure: 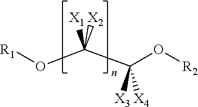
wherein n is any integer greater than 0;
wherein R₁ is selected from hydrogen, deuterium, halogen, C₁₋₁₀ alkyl, C₃₋₈ cycloalkyl, C₂₋₆ alkenyl, C₃₋₆ cycloalkenyl, C₅₋₇ heteroalkyl or C₂₋₆ alkyl ether;
wherein R₂ is selected from —CH₂CF₃, —CH₂CHF₂, —CH₂CH₂F, —CH₂OCH₃, —CH₂OCF₃, —CH₂OCH₂CH₃, —CH₂OCH₂CF₃, —CH₂OCF₂CF₃, —CH₂CF₃, —CF₂CF₃, —CH₂CF₂CF₃, —CF₂CF₂CF₃, —OCH₂CF₂CF₃or —CH₂CH₂CF₃; and
wherein X₁ to X₄ are independently selected from hydrogen, deuterium, halogen, —CH₃, —CH₂CF₃, —CH₂CHF₂, —CH₂CH₂F, —CH₂OCH₃, —CH₂OCF₃, —CH₂OCH₂CH₃, —CH₂OCH₂CF₃, —CH₂OCF₂CF₃, —CF₂CF₃, —CH₂CF₂CF₃, —CF₂CF₂CF₃, —OCH₂CF₂CF₃ or —CH₂CH₂CF₃.

2. The high-voltage, non-flammable and thermally-stable lithium metal battery of claim 1, wherein the concentration of the lithium salts in the electrolyte is no higher than 4.5M.

3. The high-voltage, non-flammable and thermally-stable lithium metal battery of claim 1, wherein the electrolyte has a boiling point of no less than 100° C.

4. The high-voltage, non-flammable and thermally-stable lithium metal battery of claim 1, wherein the electrolyte has a flash point of no less than 100° C.

5. The high-voltage, non-flammable and thermally-stable lithium metal battery of claim 1, wherein the electrolyte has an oxidation voltage of no less than 4.5 V.

6. The high-voltage, non-flammable and thermally-stable lithium metal battery of claim 1, wherein the lithium salts in the electrolyte are selected from lithium bisfluorosulfonylimide, lithium bis (trifluoromethanesulfonyl) imide, lithium bis (oxalate) borate, lithium difluoro (oxalate) borate, lithium nitrate, or any combinations thereof.

7. The high-voltage, non-flammable and thermally-stable lithium metal battery of claim 1, wherein the positive electrode comprises an aluminium current collector with a coating comprising lithium cobalt oxide, lithium manganese oxide, lithium iron phosphate, lithium nickel manganese cobalt oxide, nickel rich lithium nickel manganese cobalt oxide, lithium nickel cobalt aluminium oxide, lithium cobalt phosphate, spinel lithium nickel manganese oxide, or any combinations thereof.

8. The high-voltage, non-flammable and thermally-stable lithium metal battery of claim 1, wherein the negative electrode comprises a copper current collector coated with lithium metal.

9. The high-voltage, non-flammable and thermally-stable lithium metal battery of claim 1, wherein the separator is selected from polyethylene separator, polypropylene separator, polytetrafluoroethylene separator, polyimide separator or a multilayer composite separator.

10. The high-voltage, non-flammable and thermally-stable lithium metal battery of claim 1, wherein the change in volume of the battery under a temperature of 150° C. is no more than 10%.

11. The high-voltage, non-flammable and thermally-stable lithium metal battery of claim 1, wherein the change in battery temperature upon penetration through the battery is no more than 1° C.

12. The high-voltage, non-flammable and thermally-stable lithium metal battery of claim 1, wherein the battery reaches a temperature of less than 100° C. upon impact of 300 N, and the increase in battery temperature due to the impact will be reduced to lower than 20% in a time period of 30 minutes after the time of impact.
